(19) United States
(12) Patent Application Publication
(10) Pub. No.: US 2008/0172599 A1
(43) Pub. Date: Jul. 17, 2008

(54) Method for Reassigning a Section of a Printed Product to a New Signature

(76) Inventors: Chris Tuijn, Lier (BE); Peter De Mangelaere, Deinze (BE); Roger Baeten, Boortmeerbeek (BE)

Correspondence Address: AGFA CORPORATION;PATENT DEPARTMENT, 200 BALLARDVALE STREET, WILMINGTON, MA, 01887, US

(21) Appl. No.: 11/793,659

(22) PCT Filed: Dec. 21, 2005
(86) PCT No.: PCT/EP2005/056994

§ 371 Date: Mar. 7, 2008

Related U.S. Application Data
(60) Provisional application No. 60/648,025, filed on Jan. 28, 2005.

(30) Foreign Application Priority Data
Dec. 23, 2004 (EP) 04106972.5

(51) Int. Cl. G06F 17/00

(52) U.S. Cl. 715/227

(57) ABSTRACT

A method for reassigning a section out of a plurality of sections of a digitally represented printed product from an original signature to a new signature for producing said section, the method including (i) displaying a table on a computer display, wherein the table includes a list of items, each item representing a section and including (a) a section identifier, (b) a signature identifier associated to the section identifier and representing a signature to which the section is assigned and (c) a signature portion index indicating a portion of the signature corresponding to the section; (ii) selecting on the computer display a specific item including a specific signature portion index; and (iii) moving on the computer display the specific signature portion index from one item to another one, thereby assigning a different section to a specific signature having the specific signature portion index.

### FIELD OF THE INVENTION

The present invention relates to printed products and particularly to digital representations of such printed products.

### BACKGROUND OF THE INVENTION

In the printing and publishing environment, different players interact in order to obtain print and publishing products, such as magazines, catalogues, promotional, corporate, book or specialty products in offset, flexo, screen, digital, sheet- or web-fed printing. Such products are called “printed products” in this document. The main players that interact, in what is called in this document the “Graphic Enterprise”, are the print buyer (or customer), the people in the workcenter, and the customer service representative who is the communicator between the first two main players. Different software tools are used within the Graphic Enterprise, such as pre-press workflow systems (such as Apogee Series 3 and Apogee X from Agfa), cost estimation modules, Management Information Systems (MIS), etc. Most of these tools operate on a digital representation of the product that will be printed. When organizing and streamlining the work within the Graphic Enterprise, the method according to which the digital representation of the printed product is obtained and also the way in which the printed product will be manufactured play a central role.

Usually the printed product contains a plurality of sections that are bound together to make up the final product. The knowledge on how the sections will be positioned on the printing plates (and what sections are combined) leads to the definition of the signatures and the imposition layout (for more information, we refer to the “Handbook of Print Media, Technologies and Production Methods”, Kipphan H., Springer-Verlag, 2001).

Agfa's Delano™ software allows the players in the Graphic Enterprise to interact and to make a digital representation of a printed product.

There is still a need for an improved method for reassigning sections to signatures.

### SUMMARY OF THE INVENTION

The present invention is a method for reassigning, in a digital representation of a printed product, a section of the printed product to another signature, as claimed in independent claim 1. Preferred embodiments of the invention are set out in the dependent claims. Preferably, a method in accordance with the invention is implemented by a computer program as claimed in claim 8. The invention also includes a computer readable medium comprising program code adapted to carry out such a method, and a data processing system comprising means for carrying out such a method.

In a method in accordance with the invention, the digital representation of the printed product keeps track of the relations between the sections and the associated signatures.

As will become clearer from the examples discussed below, when manufacturing one or more printed products, sometimes sections have to be reassigned to signatures. Such an operation can be quite complex, e.g. if the sections do not all count the same number of pages.

An advantage of one embodiment of the present invention is that, in spite of this complexity, it offers a user-friendly method to perform the operation.

Further, the invention may also be applied to the simultaneous manufacture of a plurality of printed products, which adds another layer of complexity.

In this document, a page, a section and other suchlike terms may denote the physical entity, the digital representation of the physical entity, a depiction thereof on a computer display. What is meant, can be determined from the context.

A computer program denotes, in this document, an aggregate of computer program code means, that may be organized in one entity, or in a plurality of entities that may run independently of each other (e.g. generating a product structure for a printed product, and generating, based on that product structure, an imposition plan for the printed product, may be performed by two different entities: the first entity generates the product structure, and the second entity generates the imposition plan; both entities together are denoted, in this document, as “a computer program”).

### BRIEF DESCRIPTION OF THE DRAWINGS

The invention is described with reference to the following drawings without the intention to limit the invention thereto, and in which:

FIG. 1 shows a first screenshot of a computer display illustrating the invention;

FIG. 2 shows a second screenshot, resulting from the first one after application of a particular embodiment of the invention;

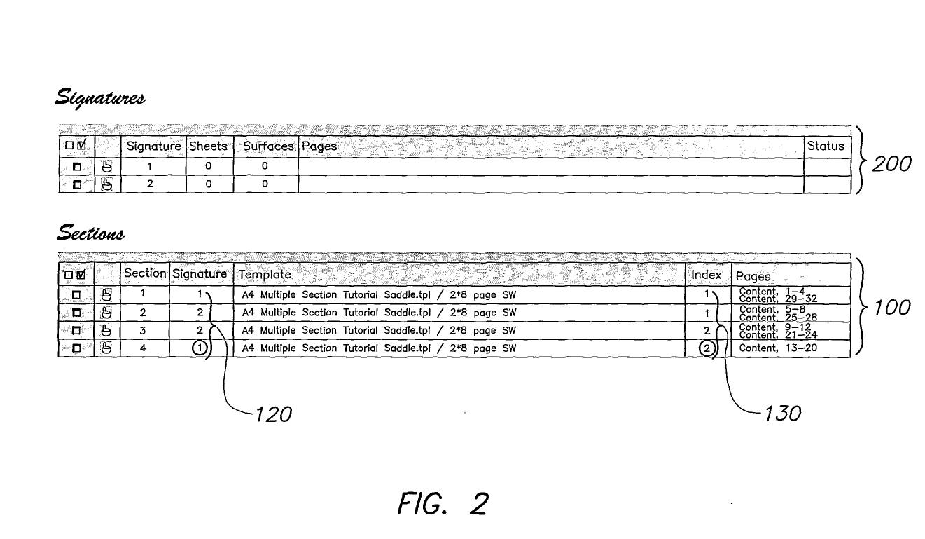

FIGS. 3 and 4 are simplified versions of the first resp. the second screenshot, and illustrate the particular embodiment of the invention in more detail;

FIG. 5 illustrates signatures and signature portion indices.

### DETAILED DESCRIPTION OF THE INVENTION

A specific embodiment of the invention is encompassed in a project management system that organizes and streamlines the work within the Graphic Enterprise.

The invention is further illustrated hereinafter by embodiments as implemented in the new version of Agfa's Delano™ software, without limiting the invention thereto.

In an old version of Delano, version 1.1, the possibilities to define imposition schemes (also called imposition plans in this document) were extended by introducing the functions to merge and split Production Components and to allow editing of the run list.

Fact remained that the only way to create an imposition layout structure in Delano was through the automatic selection of signatures out of an imposition template.

Now, in the new version of Delano, new, powerful functionality has been provided that allows to manually select signatures out of imposition templates. Full multi section support within signatures (within one Product and across different Products) has been provided as well.

In this document, we first briefly describe how the imposition specification has been implemented in the old versions 1.0 and 1.1 of Delano. Then, we explain what the ideas behind the new Delano imposition functionality are and subsequently how they are made available in the GUI, which involves several embodiments of the present invention.

For more information on the used terminology, we refer to the existing Delano 1.2, and to the corresponding manuals and documentation, which are incorporated herein by reference.

First, some Delano background is discussed.

Products and Parts

In Delano, a Product may consist of different Parts. A Part may be a cover, content, an insert. An insert is printed material, typically one or more advertisements, that is inserted between the content pages. Usually, inserts do not affect the pagination of the content; if e.g. an insert of four pages is located between page seven and page eight of the content, page eight retains its page number and does not get page number twelve. A cover may or may not be present (a self-cover means that there is no separate cover: the outer pages of the content serve as the cover). A printed product may contain two or more content Parts; an example of a printed product that contains two content Parts is a printed product containing two books, one in French and one in Dutch, so that by turning the printed product so that front and back are switched, one obtains the book in the other language.

With each Part, a list of pages is associated that are visualized in the so-called Page Status View. In addition to the so-called PDF box information (Art/safety, Trim, Bleed and Media Box), all the Pages have a specific position in the Reader's Spread View. The list of pages that is associated with a specific Part is often referred to as the Page List.

Creation Components

For each Part that is created (either during the Product creation or via a manual Part creation), a Creation Component and a Production Component will be made.

With each Component, a Task Chain can be associated that specifies how the related resources will be processed.

In a preferred embodiment, the Creation Component will contain only Tasks that work on Pages; the Creation Component created during the Part creation, will process exactly the Pages that are associated with that Part's Page List.

Production Components

During the creation of a Part, one Production Component will be created as well. By default, all the pages of that Part's Page List will be used as the input run list of that Production Component.

The Production Component's Task Chain will convert the incoming Pages as following:

Imposition: Page are transformed into structured Signatures (Signature, Sheet, Surface);

Rendering, Trapping, . . . , Plate Making: Signatures in, Signatures out;

Printing: Signatures in, Sheets out;

Printing: Signatures in, Sheets out;

etc.

The user can create extra Production Components if he wishes to do so. During the creation of a Production Component, the user indicates which Page List he will use as input for the Production Component.

This functionality allows the user to use the same Page List in different print jobs. This can be useful if specific Products are printed in parallel on different presses or if different types of production have to be prepared.

Imposition and Delano 1.0

In Delano 1.0, there are 2 ways to define an imposition scheme, one based on PJTF files and one based on Preps templates.

In order to manufacture a Product Part, different steps have to be taken, as follows.

First, the Production Component is identified. By default, Delano creates one Production Component per Product Part. Delano associates the entire list of pages in the Part (Page List) with the Production Component.

It is, however, also possible to define new Production Components. During the manual creation of a Production Component, the user specifies the Product Part this Component will manufacture.

A first way to define an imposition scheme, based on Preps imposition templates, is as follows. When editing the Production Component, the user can browse in Delano through a list of Preps files. When a Preps file has been selected (and the Component is saved), Delano will start to calculate an imposition layout scheme by using an automatic selection of signatures out of the template. To this end, Delano uses the Apogee X Imposition service which has very similar behavior as the Preps server.

The result is a list of signatures that each consume a part of the Page List.

As a result, Delano will visualize the list of signatures; the user can also have a graphic view of the signatures.

A second way to define an imposition scheme, using PJTF files, is as follows.

PJTF files are CIP3-based files that contain calculated imposition jobs; as such, they consist of detailed information that describes the different signatures and how pages are positioned on those signatures.

When selecting a PJTF file and saving the Component, Delano will create the signatures as defined in the PJTF file. The signatures can also be viewed graphically.

Imposition and Delano 1.1

In Delano 1.0, the Production Components only contain pages of one Part (Page List).

Sometimes, however, users want to combine pages of different Parts within one Product on one printing sheet. To allow, moreover, the cross product manufacturing of Parts (such as, e.g., covers) of different Products on one sheet, users even want to put pages of different Products on one sheet.

A solution that allows this is to make it possible to associate pages that come from different Parts (within one Product or across different Products) with one Production Component.

In Delano, this is realized by merging different Components.

When merging one Component with another, the first Component's run list will be extended with the pages of the second run list. The second Component will be removed.

In one embodiment, the user can manually edit the run list, in order to make sure that the pages end up on the correct position on the imposition layout.

Imposition in the New Version of Delano

From Delano 1.1 on, it is possible to define (multi section) cross-product Components that combine the manufacturing of different Product Parts in one Component. As described before, it sometimes is necessary to manually edit the run list to make sure that the pages end correctly on the imposition layout; until version 1.2, Delano did not represent the sections in the templates and therefore the user manually had to define the run list.

In the new version of Delano, the sections (and the signatures they belong to) are represented.

Single Part Components and Single Section Signature

Let us first consider the simple case in which an ordinary Production Component (which relates to 1 Part only) needs to be defined. (These single-Part Production Components are the Components that are created by default during the Product Creation. If necessary, it always is possible to create new Production Components that have a Part's run list.)

Before the Production Component can be started, the user specifies how the specific Part should be produced. This basically is equivalent with specifying what sections have to be produced and how they will be combined together. This can be done in Delano by creating a number of signatures each containing 1 or more sections.

When adding a signature in Delano, the user will have the following possibilities:

to select a template and consume the entire run list using the Auto-Select functionality (see also the discussion above of using Preps imposition templates);

to select a PJTF file and import the signatures that have been defined in this PJTF file (see also the discussion above of using PJTF files);

or create signatures one by one through selection out of a list of available imposition templates.

We will now discuss this last case in detail.

When a user hits the ‘Add signature’ button on the screen, a popup will appear in which the user first indicates which of the 3 cases he prefers. If he chooses for the manual selection of signatures, the system will display a list of available templates per binding style.

First, the binding style is selected. Supported binding styles are: Flat Work; Perfect Bound; Saddle Stitched; Come and Go; Cut and Stack.

Then, the user can select a template out of the list of available templates. After the selection, all the signatures that are defined in this template will be shown on the screen. The user then selects a specific signature out of the template and enters further details.

By clicking on the ‘Set to maximum’ button on the screen, the system will calculate how many signatures of the selected type can still be used for the remaining pages. In a preferred embodiment, the system also displays how many pages are still remaining. By clicking on the OK button, the system will now create the specified number of signatures and will consume a number of remaining pages in this process.

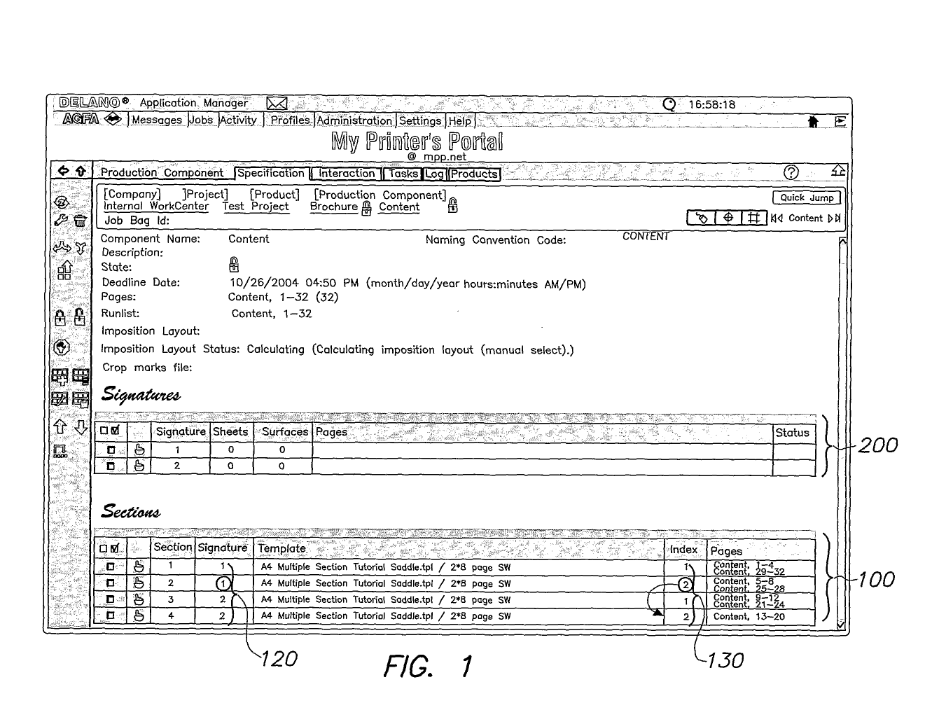

Then, a screen is displayed that is similar to the one shown in FIG. 1, but that is somewhat simpler. The screen shows two tables or lists:

a Signature List: this is the list of created signatures (corresponding to table 200 in the embodiment discussed hereinafter and shown in the screenshot of FIG. 1);

a Sections List: this is the list of sections in the above signatures (corresponding to table 100 in the embodiment of FIG. 1). Preferably, the system also indicates what pages of the original Part belong to that specific signature. If a single section signature has been chosen, there will be a 1 to 1 correspondence between signatures and sections. FIG. 1 would therefore look as follows for such a single signature case: in table 100, the columns “Section” and “Signature” would both contain sequential numbers 1, 2, 3, etc., and the contents of column “Index” (of which the meaning is discussed in the next case, below) would be the same for all rows of the table 100 (e.g. all fields equal to “1”, or empty fields, or the column “Index” may even be omitted in such a case).

Single Part Components and Multiple Section Signatures

Sometimes, it can be useful to use multiple section signatures when manufacturing a single Product Part. A typical example would be a publication in which a number of sections are in black/white and two non-consecutive sections are in process color.

For cost optimization, it may be advisory to print the two color sections together on one sheet (if possible). If the sections are not next to each other, however, a multiple section signature would be needed.

A typical example is a 32 page saddle stitched brochure consisting of 4 sections wherein the most outer and the most inner section are in color, the other ones in black-and-white.

To illustrate this four-section structure, the following notation is used:
CONTENT(8)*<CONTENT(8)<CONTENT(8)<CONTENT(8)*
   i.e. each of the four sections contains eight pages, printed recto-verso; the color pages are marked with an asterisk (*).
   Remark: in this notation, the horizontal axis models insertion, and the vertical axis models stacking; thus, a perfect bound book, having a cover of 4 pages and containing two sections of 96 pages and one section of 64 pages, is represented as follows:
COVER(4) <CONTENT(96)
   <CONTENT(96)
   <CONTENT(64)

The 32 page saddle stitched brochure of the example could be realized in Delano by selecting the appropriate saddle stitched template and selecting a 2-section signature of 8+8 pages (i.e. 8 pages recto and 8 pages verso).

In one embodiment, this results in the signature/section layout shown in FIG. 1.

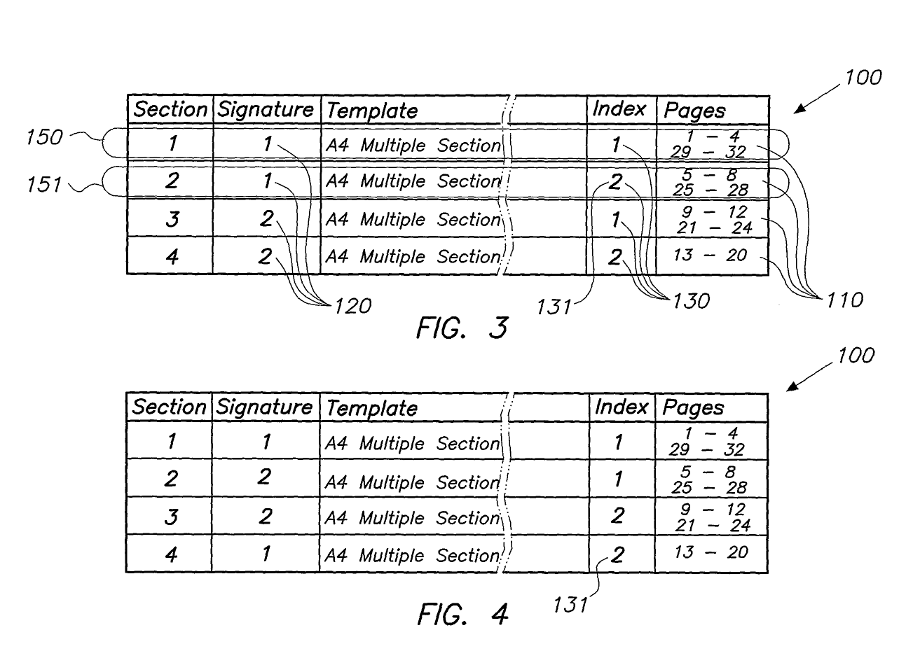

In FIG. 1, table 200 is a list of created signatures and table 100 is the list of sections in these signatures. Table 100 is shown more clearly in FIG. 3.

In FIG. 3, table 100 contains for each section a list of items 150, 151 (forming a row of the table in FIG. 3). This list of items includes: in the column headed “Section”, a numbering field for the section; in column “Signature”, a signature identifier 120 representing the signature to which the section is assigned; in column “Index”, a signature portion index 130 (discussed immediately below); and in column “Pages”, a field identifying the section—i.e. a section identifier 110—which includes in the shown embodiment the pages of the concerned section.

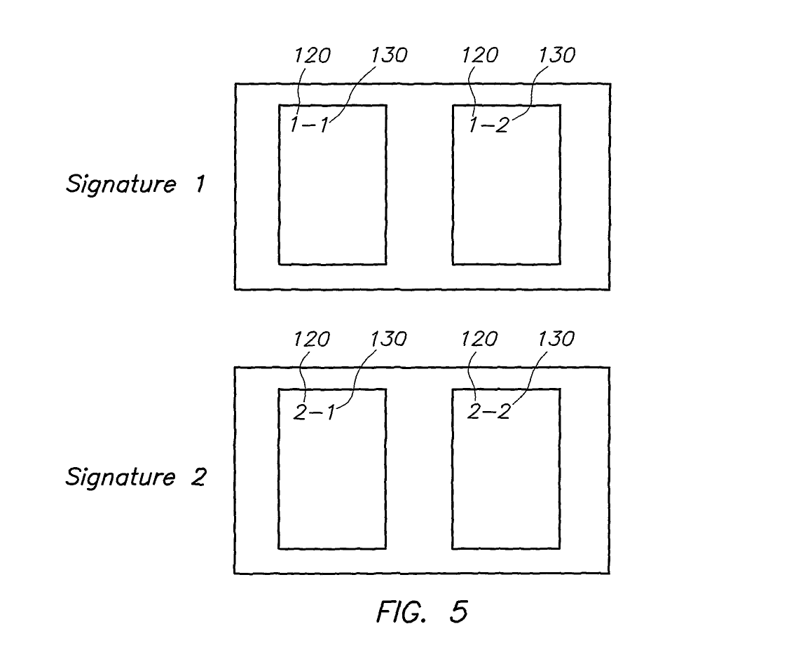

FIG. 5 shows what is meant by a signature portion index 130: signature 1 contains two different signature portions, labeled “1-1” respectively “1-2”, wherein the first number is the signature identifier 120 and the second number is the signature portion index 130. Analogously, signature 2 also contains two signature portions, labeled “2-1” and “2-2”. The case shown in FIG. 3 corresponds to the signature layout of FIG. 5 wherein four pages recto and four pages verso are allocated to a signature portion. Thus, each signature is for 8+8 pages, and together the two signatures suffice for the 32 page saddle stitched brochure.

Returning now to FIG. 3, note that the system tries to fill the first signature (with signature identifier 120 equal to “1”) with pages 1-4 and 29-32, and with pages 5-8 and 25-28. In our example, however, we want to print Section 1 (pages 1-4 and 29-32) and Section 4 (pages 13-20) together in one signature (because this is a color signature).

This can easily be realized by moving down the second signature portion of Signature 1 (that is Signature 1, Index 2), corresponding to signature portion index 131 in FIG. 3. This can be done in the Delano GUI by selecting section 151 and clicking on the blue down arrow (shown in FIG. 1). The result is, as shown in FIG. 4 and on the corresponding screenshot 2, that this signature portion 131 (now at position 4, but still labeled Signature 1, Index 2) will contain the inner pages 13-20 of the magazine; consequently, these pages (that is the inner pages) will be printed in color.

Multiple Part Components with Single Signature

Sometimes, it is required to manufacture different Parts together in one Production Component. A typical example of this practice is the printing of covers of different products on one sheet; we will designate the products as product A, product B, product C and product D.

In one embodiment, this is realized as follows.

First, one creates a multi Part Production Component. This can be realized quickly by merging one or more single Part Production Components together.

The result is a Production Component which has different ‘Source Parts’ assigned to it. When adding signatures, the user has to assign each section in the signature to a specific Source Part.

In the same notation as used in FIG. 3 (omitting the Template column, however), the section list for this case is as shown in Table 1:

TABLE 1

| Section | Signature | Index | Pages |
|---|---|---|---|
| 1 | 1 | 1 | Cover, 1-4, Part A |
| 2 | 1 | 2 | Cover, 1-4, Part B |
| 3 | 1 | 3 | Cover, 1-4, Part C |
| 4 | 1 | 4 | Cover, 1-4, Part D |

Multiple Part Components with Multiple Signatures

A first example is printing 4 different books together wherein each signature consists of a section of each of the 4 books; the Parts are called again A, B, C and D, and the section list is shown in Table 2:

TABLE 2

| Section | Signature | Template | Index | Pages |
|---|---|---|---|---|
| 1 | 1 | 4 × 8 up | 1 | Content, 1-8 |
| | | | | Content, 25-32, Part D |
| 2 | 1 | 4 × 8 up | 2 | Content, 1-8 |
| | | | | Content, 25-32, Part C |
| 3 | 1 | 4 × 8 up | 3 | Content, 1-8 |
| | | | | Content, 25-32, Part B |
| 4 | 1 | 4 × 8 up | 4 | Content, 1-8 |
| | | | | Content, 25-32, Part A |
| 5 | 2 | 4 × 8 up | 1 | Content, 9-24, Part D |
| 6 | 2 | 4 × 8 up | 2 | Content, 9-24, Part C |
| 7 | 2 | 4 × 8 up | 3 | Content, 9-24, Part B |
| 8 | 2 | 4 × 8 up | 4 | Content, 9-24, Part A |

Variation: as a variation on this theme, one might consider, for instance, a French and an English publication, where the required quantity of the English publications is three times the quantity of the French publications. One might consider printing the publication (if possible) on a 4-section signature wherein the three first signature portions are taken by a section of the English publication while the fourth signature portion is taken by the associated section of the French publication.

In order to realize this, we first have to create a component to which three instances of the English Part and one instance of the French Part have to be assigned. This can be realized by merging the English Part Production Component once with itself and merging it then again with a newly created English Part Production Component. Then, this component will contain three instances of the English Part run list and therefore it still has to be merged with the French Part component.

Example: in this example, 75000 copies of an English publication (24 pages content) and 25000 copies of a French publication (24 pages) are generated by repeating the English publication three times on each flat and taking the French publication only once.

The 24 pages are realized with 3 signatures: one 4×8 up signature and twice a 4×2 up signature. The sections are combined using saddle stitching.

The corresponding section list is shown in Table 3:

TABLE 3

| Section | Signature | Template | Index | Pages |
|---|---|---|---|---|
| 1 | 1 | 4 × 8 up | 1 | Content, 1-8 |
| | | | | Content, 17-24 |
| 2 | 1 | 4 × 8 up | 2 | Content #2, 1-8 |
| | | | | Content #2, 17-24 |
| 3 | 1 | 4 × 8 up | 3 | Content #3, 1-8 |
| | | | | Content #3, 17-24 |
| 4 | 1 | 4 × 8 up | 4 | Content French, 1-8 |
| | | | | Content French, 17-24 |
| 5 | 2 | 4 × 4 up | 1 | Content, 9-10 |
| | | | | Content, 15-16 |
| 6 | 2 | 4 × 4 up | 2 | Content #2, 9-10 |
| | | | | Content #2, 15-16 |
| 7 | 2 | 4 × 4 up | 3 | Content #3, 9-10 |
| | | | | Content #3, 15-16 |
| 8 | 2 | 4 × 4 up | 4 | Content French, 9-10 |
| | | | | Content French, 15-16 |
| 9 | 3 | 4 × 4 up | 1 | Content, 11-14 |
| 10 | 3 | 4 × 4 up | 2 | Content #2, 11-14 |
| 11 | 3 | 4 × 4 up | 3 | Content #3, 11-14 |
| 12 | 3 | 4 × 4 up | 4 | Content French, 11-14 |

General Behavior

The default Delano behavior will create one Production Component per Part. The Production Planner software module decides which Production Components will be manufactured together. If two or more Production Components have to be realized by one job, they are merged.

The result of this merger is a Production Component that has several Part run lists attached to it. It is also possible to have multiple instances of the same Part associated with a specific Production Component.

In the next phase, the user has to define the signatures and sections. This can be done in 2 ways:

1) By selecting one template and using the Auto Select mechanism to define the signatures. In this case, the run list as defined during the merger process will be fed to the Preps server to calculate where which page will go (this is the Delano 1.1 behavior). The problem of this behavior is that the user has to have an in-depth knowledge of the automatic signature selection (and binding style) to make sure that the pages end up at the right positions.
2) By manually selecting the signatures/sections. Please not that in this case the original run list (as generated by the merger actions) will NOT be used (except for the identification of the different Parts that make up this run list).

Assume we have created a Production Component that exists of n Parts; each Part (Pₙ) has a number of pages (run lists) assigned to it (1 . . . pᵢ).

The user now has to consume each of these run lists; with consuming we mean that all the pages of these run lists are assigned to sections in the manually selected signatures.

If a signature has been selected, the user indicates for each section which Part's run list (“Source Part”) will be used. Based on the binding style, the system will then calculate for each section in the signature the pages that will be taken. If the binding style is saddle stitched, half of the pages in the beginning and half of the last remaining pages will be taken, otherwise the pages are taken from the beginning.

This process is repeated until all pages of all Source Parts have been consumed exactly. At that point, the server will start calculating the exact imposition layout. As a consequence, the flat preview will become available in Delano.

In the GUI, two tables are displayed: the table of signatures, and the list of sections in these signatures.

The order in which the sections appear in the GUI corresponds to how they consume the run list within their Source Part.

The user can move these sections up and down; the result is that the pages will end up on other signatures (flats). This can be useful to group all pages that require a specific processing (black/white, process color, HIFI, gloss, special paper etc.).

Example 1: two 16-page brochures to be printed together, using perfect bound signatures with two sections, each containing 8 pages.

Assuming the Parts associated with the two products are called Part1 and Part2, this gives the following sections:

| | | | |
|---|---|---|---|
| Section 1 | Signature 1 | Index 1 | Part 1 (1-8) |
| Section 2 | Signature 1 | Index 2 | Part 2 (1-8) |
| Section 3 | Signature 2 | Index 1 | Part 1 (9-16) |
| Section 4 | Signature 2 | Index 2 | Part 2 (9-16) |

Example 2: two 16-page brochures to be printed together, using a saddle-stitch signature with two sections, each containing eight pages.

Assuming the Parts associated with the two products are called Part1 and Part2, this gives the following sections:

| | | | |
|---|---|---|---|
| Section 1 | Signature 1 | Index 1 | Part 1 (1-4, 13-16) |
| Section 2 | Signature 1 | Index 2 | Part 2 (1-4, 13-16) |
| Section 3 | Signature 2 | Index 1 | Part 1 (5-12) |
| Section 4 | Signature 2 | Index 2 | Part 2 (5-12) |

The invention is not limited to the embodiments disclosed hereinbefore. To give a very simple example, instead of using a table 100 wherein each row corresponds to a section 150, a column in a table could correspond to a section.

Those skilled in the art will appreciate that numerous modifications and variations may be made to the embodiments disclosed above without departing from the scope of the present invention as defined by the appending claims.

1-9. (canceled)

10. A method for reassigning a selected section from a plurality of sections of a digitally represented printed product from an original signature to a new signature for producing said selected section, the method comprising:
displaying a table on a computer display, wherein said table includes a list of items, each item representing a section and including (a) a section identifier, (b) a signature identifier associated to said section identifier and representing a signature to which said section is assigned and (c) a signature portion index indicating a portion of said signature corresponding to said section;
selecting on said computer display a specific item including a specific signature portion index; and
moving on said computer display said specific signature portion index from one item to another item, thereby assigning the selected section to a specific signature having said specific signature portion index.

11. The method according to the claim 10 further comprising displaying a second table on said computer display wherein said second table includes a list of signatures created for producing said printed product.

12. The method according to claim 10 wherein a second list of section identifiers further comprises additional section identifiers representing sections of a second printed product.

13. The method according to claim 12 further comprising displaying a second table on said computer display wherein said second table includes a list of signatures created for producing said printed product.

14. The method according to claim 12 wherein said second printed product is equal to said printed product.

15. The method according to claim 14, further comprising displaying a second table on said computer display wherein said second table includes a list of signatures created for producing said printed product.

16. The method according to claim 12 wherein said second printed product is different from said printed product.

17. The method according to claim 16, further comprising displaying a second table on said computer display wherein said second table includes a list of signatures created for producing said printed product.

18. The method according to claim 17, wherein said second table further includes an additional list of signatures for producing said second printed product.

19. A data processing system comprising computer code for carrying out a method for reassigning a selected section from a plurality of sections of a digitally represented printed product from an original signature to a new signature for producing said selected section, the method comprising the steps of:
displaying a table on a computer display, wherein said table includes a list of items, each item representing a section and including (a) a section identifier, (b) a signature identifier associated to said section identifier and representing a signature to which said section is assigned and (c) a signature portion index indicating a portion of said signature corresponding to said section;
selecting on said computer display a specific item including a specific signature portion index; and
moving on said computer display said specific signature portion index from one item to another item, thereby assigning the selected section to a specific signature having said specific signature portion index.

20. A computer readable medium comprising program code adapted to carry out a method for reassigning a selected section from a plurality of sections of a digitally represented printed product from an original signature to a new signature for producing said selected section, the method comprising the steps of:
displaying a table on a computer display, wherein said table includes a list of items, each item representing a section and including (a) a section identifier, (b) a signature identifier associated to said section identifier and representing a signature to which said section is assigned and (c) a signature portion index indicating a portion of said signature corresponding to said section;
selecting on said computer display a specific item including a specific signature portion index; and
moving on said computer display said specific signature portion index from one item to another item, thereby assigning the selected section to a specific signature having said specific signature portion index.
